(19) United States
(12) Patent Application Publication
(10) Pub. No.: US 2023/0233974 A1
(43) Pub. Date: Jul. 27, 2023

(54) MODULAR FILTER SYSTEM

(71) Applicant: MAHLE International GmbH, Stuttgart (DE)

(72) Inventors: Florian Klein, Bad Liebenzell (DE); Holger Laux, Dietingen (DE); Markus Michael, Ilsfeld (DE)

(21) Appl. No.: 18/095,524

(22) Filed: Jan. 10, 2023

(30) Foreign Application Priority Data
Jan. 11, 2022 (DE) 10 2022 200 203.2

(51) Int. Cl. B01D 46/00

(52) U.S. Cl. CPC B01D 46/0087; B01D 46/0005; B01D 2273/10; B01D 2279/50

(57) ABSTRACT

A combined bypass filter element module is disclosed. The combined bypass filter element module includes at least one filter slot for receiving at least one filter element that can be arranged in the at least one filter slot. A bypass flap device is arranged in a flow direction in parallel with the at least one filter slot.

### CROSS-REFERENCE TO RELATED APPLICATION

This application claims priority to Germany Application No. DE 10 2022 200 203.2 filed on Jan. 11, 2022, the contents of which are hereby incorporated by reference in its entirety.

### TECHNICAL FIELD

The present invention relates to a combined bypass filter element module. In addition, the invention relates to a building kit for a filter system and to a filter system produced from such a building kit and to an air-conditioning system having such a filter system.

### BACKGROUND

By using platform strategies in vehicle development it is necessary to be able to depict a large field of operating conditions with one HVAC design. Such a design is to offer an adequate filtration and also a manageable filter service life. It is conceivable that only a part of a requirement spectrum is covered by a so-called one-filter solution, wherein however for the complete coverage of the application spectrum a two-filter solution with serially connected filter elements may be additionally required. In a further step, there may also be fields of application of the platform that render a bypass of one of the filter elements necessary. However, this cannot be realised with platforms known to date.

The present invention therefore deals with the problem of stating a combined bypass filter element module with which the disadvantages known from the prior art can be overcome.

According to the invention, this problem is solved through the subject of the independent claim(s). Advantageous embodiments are subject of the dependent claims.

### SUMMARY

The present invention is based on the general idea of stating a combined bypass filter element module having, in particular, a frame and a filter element that can be arranged in parallel in this frame, and a bypass flap device. Thus, the combined bypass filter element module has a filter slot for receiving at least one filter element that can be arranged therein and a bypass flap device that is arranged in the flow direction in parallel with the at least one filter element. In a platform it is thus possible for the first time to insert a filter element or such a bypass filter element module into an insertion slot arranged there, as a result of which a bypass solution can be provided which in the past could only be realised with two parallel insertion slots and by leaving one of these insertion slots vacant. However, the bypass could not be regulated in this case. With the combined bypass filter element module according to the invention it is possible for the first time to cover a requirement spectrum of a platform significantly more broadly than has been possible with filter elements or closure elements known from the prior art to date. In particular it is thus also possible to configure significantly more variable a filter system having a housing and at least two insertion slots already employed in the past than has merely been possible in the past by inserting filter elements into a respective insertion slot or leaving such vacant. It is also conceivable that a filter capacity can be individually adjusted in that for example upon a corresponding requirement the entire insertion slot is provided by means of a large filter element, while in the case of a low requirement, the combined bypass filter element module is employed, in which a filter element surface is significantly reduced.

Practically, the bypass flap device comprises a pivotable flap or a sliding flap. A pivotable flap can make possible an extremely simple control of a bypass flow, wherein with closed bypass flap the bypass flap device serves as closure element. However, purely theoretically, louvre solutions or slat solutions are obviously also conceivable, which make possible controlling an air flow through the bypass flap device. A sliding flap likewise makes possible an easy adjustment since sliding usually takes place transversely or obliquely to the flow.

Practically, the filter element is replaceable. So as not having to completely replace the combined bypass filter element module when a filter element is to be replaced, i.e. together with the bypass flap device, the filter element is replaceable in that it can be for example pulled out of the filter slot of the bypass filter element module and replaced with a new one. By way of this, the bypass filter element module can be employed over the long term since the bypass flap device as such does not wear.

Further, the present invention is based on the general idea of offering a building kit for a modular filter system by means of which a wide variety of requirements can be individually realised. The building kit according to the invention has a housing with at least one first insertion slot and one second insertion slot. Likewise, the building kit according to the invention includes at least one filter element, which can be inserted into one of the insertion slots. By way of at least one closure element, which can be inserted into one of the insertion slots, the same can alternatively also be closed. Finally, the building kit according to the invention includes at least one combined bypass filter element module corresponding to the preceding paragraphs with at least one filter element and a bypass flap device arranged parallel thereto. The combined bypass filter element module can likewise be inserted into one of the insertion slots. Obviously, a variant without combined bypass filter element module can also be realised generally. With the building kit according to the invention, a wide variety of embodiments of the modular filter system can thus be realised comparatively easily by inserting different components into the associated insertion slots. The filter element, the closure element and the combined bypass filter element module thus constitute replacement inserts, which by a different combination and/or an omission make possible a wide variety of filter systems. Here it is obviously clear that the closure element need not be but can be part of the building kit. Further, it is conceivable that the housing additionally comprises a third insertion slot for receiving a further closure element, a further filter element or a further combined bypass filter element module. The major advantage of such a building kit is that a wide variety of variants of the filter system can be realised with one housing by individually equipping the individual insertion slots with filter element, closure element or bypass filter element module. When, in addition, at least two different housings are provided in the building kit or further components that can be inserted into the respective insertion slot, the diversification can be significantly broadened further.

In an advantageous further development of the building kit according to the invention, the first insertion slot and the second insertion slot are different in size. This offers the major advantage that combined with an associated filter element, an associated closure element or an associated bypass filter element module a so-called poka-yoke system can be created, which excludes an incorrect installation of a component not intended for the respective insertion slot, since it does not fit. Because of this it is also possible in particular to have the modular filter system assembled by simple workers.

In a further advantageous embodiment of the building kit according to the invention, the first insertion slot and the second insertion slot are arranged one after another in the flow direction. Because of this it is possible for example to realise different filter stages, wherein in the flow direction for example a coarse filter can be inserted first and subsequently a fine filter in the second insertion slot. It is also conceivable that a combined bypass filter element module is inserted in the second insertion slot so that, depending on actuation of the bypass flap device employed in the bypass filter element module, merely one filter stage is flowed through with open bypass flap device, while a two-stage filtration is available with closed bypass flap device. Obviously, the housing can also comprise for example three insertion slots, wherein in the flow direction a filter element is inserted in the first insertion slot and in the two following insertion slots, a bypass filter element module each is inserted which contain for example different filter elements, so that depending on the opening state of the two bypass flap devices, a wide variety of filter stages can be realised.

Practically, the housing comprises a fresh air inlet and a circulating air inlet, so that it can be employed as housing in an air-conditioning system of a motor vehicle. There, a fresh air flap device or a bypass filter element module can be employed in the region of the fresh air inlet while in the region of the circulating air inlet a circulating air flap device or a bypass filter element module is inserted. When for example a fresh air flap device is employed there, it is usually arranged upstream of the first insertion slot and of the second insertion slot, whereas the circulating air flap device is arranged upstream of the second insertion slot. By way of this, a flow, in a circulating air mode, can merely take place through the filter element inserted into the second insertion slot, while in a fresh air mode, a two-stage filtration or, provided that a bypass filter element module is inserted into the second insertion slot, a two-stage filtration or likewise a single-stage filtration are possible, provided that the bypass flap device of the bypass filter element module inserted into the second insertion slot is open.

Further, the present invention is based on the general idea of stating a modular filter system which is produced from the previously described building kit. Such a modular filter system is extremely variable in construction, as a result of which a wide variety of platforms, for example in vehicle construction, can be equipped with filter systems produced from the building kit. The same applies also to an air-conditioning having such a modular filter system.

Further important features and advantages of the invention are obtained from the subclaims, from the drawings and from the associated figure description by way of the drawings.

It is to be understood that the features mentioned above and still to be explained in the following cannot only be used in the respective combination stated, but also in other combinations or by themselves without leaving the scope of the present invention.

Preferred exemplary embodiments of the invention are shown in the drawings and are explained in more detail in the following description, wherein same reference numbers relate to same or similar or functionally same components.

### BRIEF DESCRIPTION OF THE DRAWINGS

It shows, in each case schematically,

FIG. 1 a view of a combined bypass filter element module,

FIG. 2 a modular filter system having a housing and a bypass filter element module inserted therein,

FIG. 3 a modular filter system produced from a building kit according to the invention with a filter element inserted into an associated insertion slot,

FIG. 4 a representation as in FIG. 2, however with a filter element arranged downstream of the bypass filter element module,

FIG. 5 a filter system produced from a building kit for an HVAC system with a bypass filter element module according to the invention in a first insertion slot,

FIG. 6 a representation as in FIG. 5, however with a filter element arranged in the first insertion slot.

### DETAILED DESCRIPTION

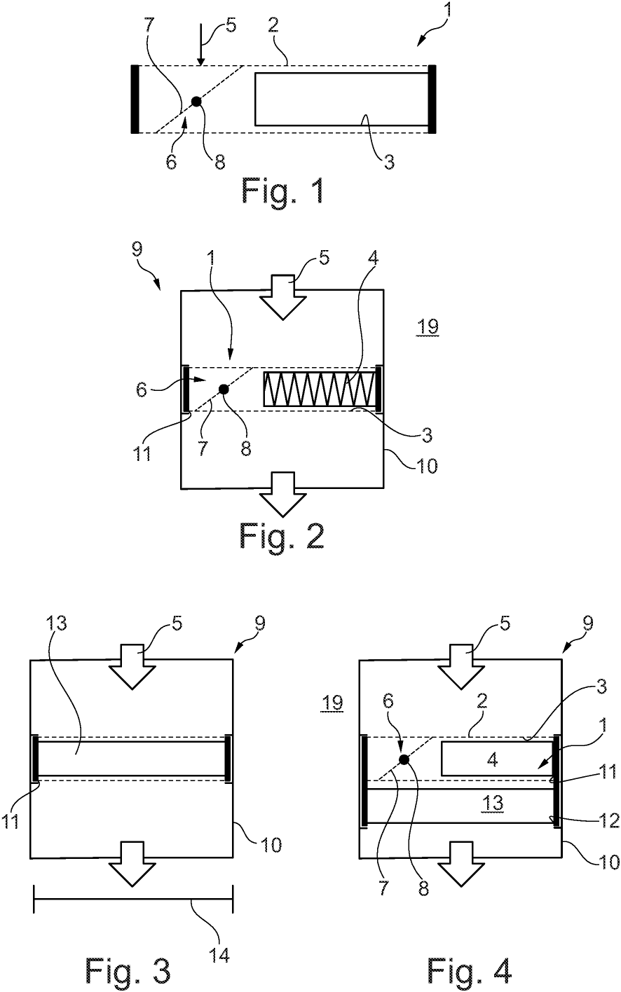

According to FIG. 1, a combined bypass filter element module 1 according to the invention comprises a frame 2 and at least one filter slot 3 for receiving for example a filter element 4 (see FIG. 2). In the flow direction 5 in parallel with the at least one filter slot 3 or the filter element 4 arranged therein, a bypass flap device 6 is arranged, via which a flow through the filter slot 3 and the filter element 4 arranged therein can be adjusted. With closed bypass flap device 6, there is thus an almost 100% flow through the filter element 4, while this percentage, with an increasing opening degree of the bypass flap device 6, can be lowered to near 0%.

In the drawn case, the bypass flap device 6 has a pivotable flap 7 which is pivotably mounted for example about an axis 8 running perpendicularly to the sheet plane. Alternatively, a sliding flap is also conceivable. The filter element 4 that can be arranged in the filter slot 3 is replaceable, as a result of which only the used-up filter element 4 but not the entire bypass filter element module 1 need be replaced during a regular maintenance.

According to FIGS. 2 to 6, a modular filter system 9 according to the invention is shown, which is assembled from a building kit for such a filter system 9. This building kit has for example a housing 10 with a first insertion slot 11 and a second insertion slot 12. According to FIGS. 2 and 3, the housing 10 of the modular filter system 9 is merely drawn in the region of the first insertion slot 11. In addition, the building kit according to the invention has at least one filter element 13, which can be optionally inserted into the first insertion slot 11 or the second insertion slot 12 or further insertion slots which are not drawn. A closure element 14 can likewise be provided, which, with insertion slots 11, 12 arranged next to one another in the flow direction 5, can close one of the insertion slots 11, 12 by insertion. Further, the building kit includes at least one combined bypass filter element 1 which can likewise be inserted into one of the insertion slots 11, 12 (see in particular FIGS. 2, 4 and 5).

Here it is obviously clear that the second insertion slot 12 is fixedly provided in the housing 10 and the first insertion slot 11 can be optionally equipped with the bypass filter module. Thus, the first insertion slot 11 can also remain blank.

By way of the building kit according to the invention it is thus possible to produce a wide variety of filter systems 9 in a comparatively flexible manner to suit requirements without elaborate changes of the housing 10 being necessary for this purpose.

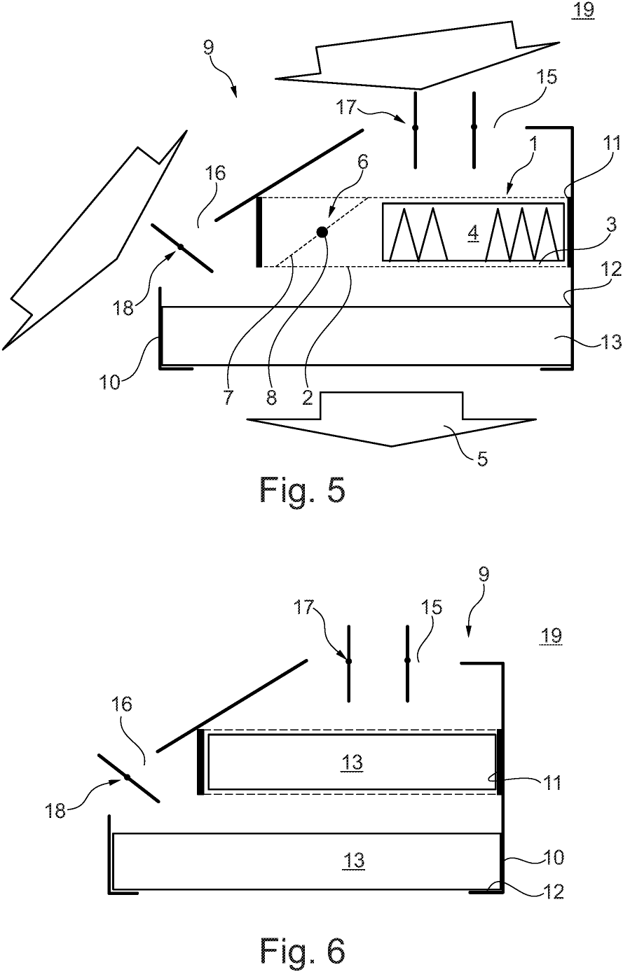

Viewing the first and second insertion slot 11, 12 according to FIGS. 5 and 6 it is noticeable that these are formed different in size, as a result of which suitable filter elements 13, closure elements 14 or combined bypass filter element modules 1 each have to be kept in stock and incorrect installation can thereby be reliably excluded. In the embodiment of the modular filter system 9 according to the invention, produced from the building kit, the housing 10 comprises identically sized insertion slots 11, 12 located in the flow direction 5 one after the other. By way of different-sized insertion slots 11, 12 and associated different-sized filter elements 13, closure elements 14 or bypass filter element modules 1, an installation can be significantly simplified since there is a positive connection between the respective components 1, 13, 14 and the respective associated insertion slot 11, 12.

Viewing the modular filter system 9 according to FIGS. 4 to 6 it is evident that the first insertion slot 11 and the second insertion slot 12 are arranged one after the other in the flow direction 5. In addition, the housing 10 according to FIGS. 5 and 6 has a fresh air inlet 15 and a circulating air inlet 16, wherein in the region of the fresh air inlet 15 a fresh air flap device 17 and in the region of the circulating air inlet 16 a circulating air flap device 18 are arranged. The fresh air flap device 17 is arranged upstream of the first insertion slot 11 and of the second insertion slot 12, while the circulating air flap device 18 is merely arranged upstream of the second insertion slot 12. Through different positions of the fresh air flap device 15, the circulating air flap device 18 and the bypass flap device 6 of the bypass filter element module 1, a wide variety of flow variants, in particular also a one or two-stage filtration, can be made possible. When for example the fresh air flap device 15 is closed, there is a flow through the housing 10 of the modular filter system 9 in the circulating air mode, namely via the circulating air inlet 16 and the filter element 13 arranged in the second insertion slot 12. If a pure fresh air operation is desired, the circulating air flap device 18 can be closed and the fresh air flap device 15 opened, wherein the bypass flap device 6 with a single-stage filtration is at least partially opened and with a two-stage filtration closed, so that there is initially a flow through the filter element 4 in the first insertion slot 11 and subsequently of the filter element 13 in the second insertion slot 12. Obviously, a wide variety of mixed operating modes are also conceivable.

With the building kit according to the invention and the bypass filter element module 1 according to the invention contained therein, a wide variety of filter systems 9 can be extremely flexibly adapted to suit a wide variety of requirements. Purely theoretically it is even conceivable that instead of the bypass flap device 6 a closure element (not shown) that can be inserted in the bypass filter element module 1 is provided there.

A wide variety of filter systems 9 can be easily constructed with the building kit, in particular using a housing 10 that is always the same, wherein a use without bypass flap device 6 is also conceivable (see FIG. 6), so that in this case an activation and a mechanism or actuators for the bypass flap device 6 can be omitted. By variously dividing the surface between bypass flap device 6 and filter slot 3, further finally-stepped distinctions and thus further different bypass filter element modules 1 can be additionally created. The filter system 9 according to the invention can be employed for example in an air-conditioning system 19 of a motor vehicle which is not described in more detail.

1. A combined bypass filter element module, comprising:
at least one filter slot for receiving at least one filter element that can be arranged therein the at least one filter slot, and
a bypass flap device that is arranged in a flow direction in parallel with the at least one filter slot.

2. The combined bypass filter element module according to claim 1,
wherein the bypass flap device comprises a pivotable flap or a sliding flap.

3. The combined bypass filter element module according to claim 1, wherein the at least one filter element is replaceable.

4. A building kit for a modular filter system, comprising:
a housing with at least one first insertion slotand a second insertion slot,
at least one filter element that is insertable into one of the at least one first insertion slot and the second insertion slot,
at least one combined bypass filter element module that is alternatively insertable into the other one of the at least one first insertion slot and the second insertion slot, the at least one combined bypass filter element module including at least one filter slot for receiving at least one further filter element and a bypass flap device that is arranged in a flow direction in parallel with the at least one filter slot.

5. The building kit according to claim 4, wherein the at least one first insertion slot and the second insertion slot are different in size.

6. The building kit according to claim 4, wherein the at least one first insertion slot and the second insertion slot are arranged in the flow direction one after the other.

7. The building kit according to, claim 4, wherein the housing comprises a fresh air inlet and a circulating air inlet.

8. The building kit according to claim 7, wherein in a region of the fresh air inlet a fresh air flap device is arranged and in a region of the circulating air inlet a circulating air flap device is arranged.

9. The building kit according to claim 8, wherein the fresh air flap device is arranged upstream of the at least one first insertion slot and of the second insertion slot, and the circulating air flap device is arranged upstream of the second insertion slots.

10. The building kit according to, claim 4, further comprising at least one closure element that is insertable into and closes one of the at least one first insertion slot and the second insertion slot.

11. A modular filter system produced from the building kit according to claim 4.

12. An air-conditioning system, comprising: a modular filter system the modular filter system including:
a housing with a first insertion slot and a second insertion slot;
at least one filter element arranged in one of the first insertion slot and the second insertion slot;
a combined bypass filter element module arranged in the other one of the first insertion slot and the second insertion slot, the combined bypass filter element module including at least one filter slot with at least one further filter arranged in the at least one filter slot, and a bypass flap device that is arranged in parallel with the at least one filter slot relative to a flow direction.

13. The air-conditioning system according to claim 12, wherein the first insertion slot and the second insertion slot are different in size.

14. The air-conditioning system according to claim 12, wherein the first insertion slot and the second insertion slot are arranged one after the other in the flow direction.

15. The air-conditioning system according to claim 12, wherein the bypass flap device comprises a pivotable flap or a sliding flap.

16. The air-conditioning system according to claim 12, wherein the housing comprises a fresh air inlet and a circulating air inlet.

17. The air-conditioning system according to claim 16, further comprising a fresh air flap device arranged at the fresh air inlet and a circulating air flap device arranged at the circulating air inlet.

18. The air-conditioning system according to claim 17, wherein the fresh air flap device is arranged upstream of the first insertion slot and of the second insertion slot relative to the flow direction, and the circulating air flap device is arranged upstream of the second insertion slot relative to the flow direction.

19. The air-conditioning system according to claim 12, further comprising at least one closure element that is inserted into and closes one of the first insertion slot and the second insertion slot.

20. The air-conditioning system according to claim 12, wherein the combined bypass filter element module is arranged upstream of the at least one filter element relative to the flow direction.
